(19) United States
(12) Patent Application Publication
(10) Pub. No.: US 2010/0021595 A1
(43) Pub. Date: Jan. 28, 2010

(54) Dairy Product and Process

(75) Inventor: Ganugapati Vijaya Bhaskar, Palmerston North (NZ)

Correspondence Address: KNOBBE MARTENS OLSON & BEAR LLP, 2040 MAIN STREET, FOURTEENTH FLOOR, IRVINE, CA, 92614, US

(73) Assignee: FONTERRA CO-OPERATIVE GROUP LIMITED, Auckland (NZ)

(21) Appl. No.: 12/439,471

(22) PCT Filed: Aug. 28, 2007
(86) PCT No.: PCT/NZ07/00231

§ 371 Date: Oct. 13, 2009

(30) Foreign Application Priority Data
Aug. 28, 2006 (NZ) 549470

(51) Int. Cl. A23C 9/14; A23C 9/146

(52) U.S. Cl. 426/271; 426/334

(57) ABSTRACT

The invention provides a method for stabilising a food or drink. The method comprises including a calcium-depleted milk protein concentrate in the food or drink.

### TECHNICAL FIELD

The invention relates to the use of milk protein concentrates for preparing protein stabilised foods.

### BACKGROUND ART

Caseinates, especially sodium caseinates have long been used in the stabilisation of oil-in-water emulsions in the food industry.

Caseinates are prepared typically by dissolving a casein slurry in alkali (sodium hydroxide for sodium caseinate) and spray drying. Production costs are high and flavour can limit their applications. Caseinates have a label of identity of their own. Products where caseinate is declared on the label, such as cheese, tend to be viewed as inferior. Caseinates are very high in protein, which may be excessive for the required application.

Poarch (U.S. Pat. No. 4,202,907) discloses that a modified sodium caseinate may be prepared from milk by replacing calcium ions with sodium ions using treatment with a suitable ion exchange resin and then reacting the material with rennet. The enzyme modified sodium caseinate is useful in the preparation of gels with comminuted meat (sausages and the like). Heat is used to set the mixture and produce a gel.

Stahl & Yuan (U.S. Pat. No. 4,450,182) disclose the preparation of a modified skim milk ingredient useful for the preparation of aerated desserts, foamed frozen desserts and foamed or whipped foodstuffs, by contacting skim milk with a weak acid exchange resin to replace calcium ions with sodium or potassium ions.

Yoshiya & Masakazu in application JP 63-188346 disclose the treatment of skim milk using a mixed resin ion exchange process where a proportion of the resin is charged with hydrogen ions and the remainder with sodium ions to produce a de-calcified ingredient with useful properties that include high solubility, heat stability, emulsification and whipping. These applicants further disclose that the mixed bed system is not straight forward to operate in that it is necessary to pay attention to the even mixing of the two resins and also disclose that without the use of the mixed resin technique and its complex regeneration techniques, a single ion resin in the sodium form causes large undesirable shifts in pH (pH 6.6-8.9) in the treated milk stream (see FIG. 1 of the Yoshiya & Masakazu application).

Bhaskar et al. in WO01/41578 disclose the preparation of a calcium depleted milk protein concentrate having improved solubility by using ion exchange (to replace a portion of the calcium with sodium). This ingredient is useful as a cheese milk extender that allows cheese manufacturers to increase their yield and avoid the problem of insoluble matter causing the fault of cheese nuggets. In the cheese milk extension application, the final food composition contains typically 10-50% protein that is derived from the modified MPC ingredient.

Bhaskar et al. in WO01/41579 disclose the preparation of a translucent milk beverage by replacing a sufficiently large fraction of the calcium ions with sodium ions in skim milk.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the present invention to provide a method for stabilising oil-in-water emulsions and/or stabilised products and/or provide the public with a useful choice.

### DISCLOSURE OF THE INVENTION

The invention concerns milk protein retentates treated by ion exchange to replace a substantial proportion of the calcium with monovalent cations and dried to form a proteinaceous ingredient useful in the preparation of emulsified or protein stabilised food products.

The calcium depleted milk protein concentrate can be used to prepare protein stabilised food products. Without being bound to particular theory, where oil or fat is dispersed in an aqueous medium, or water is dispersed in the lipid phase, the protein stabilised food product can be described as emulsified. In systems with little fat, stabilisation can surprisingly take the form of benefits to texture or reduced syneresis.

In one aspect the invention provides a method for stabilising a food or drink, wherein the method comprises adding a calcium-depleted milk protein concentrate to a food or drink.

In another aspect the invention provides a method for preparing a protein stabilised food or drink, comprising mixing a calcium-depleted milk protein concentrate with aqueous dispersion of fat or protein, and subsequently mixing the resulting dispersion with an aqueous milk product or another food or drink comprising water.

In another aspect the invention provides a method for preparing a protein stabilised food or drink, comprising including a calcium-depleted milk protein concentrate in a composition comprising an aqueous phase and a lipid phase, and mixing the composition to form a stabilised emulsion.

In a further aspect the invention provides a method for preparing a protein stabilised food or drink, comprising mixing a calcium-depleted milk protein concentrate with aqueous dispersion of fat, preferably in the form of oil droplets, and subsequently mixing the resulting emulsion with an aqueous milk product or another food or drink comprising water.

In another aspect, the invention provides a further method for preparing a protein stabilised food or drink. Dried milk protein concentrate is dissolved in an aqueous fluid. To the solution, a lipid composition is added and shear applied to form a dispersion or emulsion.

In another aspect the invention provides a method for preparing a protein stabilised food or drink, comprising:

(a) dissolving a dried milk protein concentrate in an aqueous fluid
(b) adding a lipid or protein composition, and
(c) applying shear to form a dispersion or emulsion.

Preferably in the invention, the milk protein concentrate has been prepared using replacement of calcium ions by monovalent cations, by contact with a single cation exchange resin.

Preferably the milk protein concentrate is not treated with rennet or other enzyme compositions.

The food, drinks and emulsions produced by the methods of the invention may be treated in a variety of ways, for example:
(a) concentrated, for example by ultrafiltration or evaporation,
(b) mixed with a stream containing protein or carbohydrate or a mixture of protein or carbohydrate,
(c) heated, including pasteurisation or sterilisation,
(d) dried, e.g. spray dried,
(e) chilled,
(f) frozen,
(g) combined with optional ingredients such as a thickening agent, flavouring, sweetener, acidulant, colouring, common salt, vitamins and bioactives, and optionally treated according to options (a) to (f),
   to produce an edible product. Usually, the product is packaged.

The food composition prepared using the calcium-depleted milk protein concentrate preferably contains from 0.01% to 10% w/w of the ingredient (expressed on a dry basis [DB]), more preferably from 0.1% to 5% DB of the calcium-depleted MPC.

In a further aspect the invention provides an emulsified product comprising an oil-in-water emulsion stabilised by a calcium-depleted milk protein concentrate.

The invention is particularly useful where components to be used to form the emulsion are initially in separate aqueous and lipid phases. For example, the invention may be used to incorporate an oil into a milk.

The invention is also useful for stabilising suspensions of proteins, for example casein micelles and insoluble proteins.

The term “milk protein concentrate” (MPC) refers to a milk protein product in which greater than 40%, preferably greater than 50%, more preferably greater than 55%, most preferably greater than 70% of the solids-not-fat (SNF) is milk protein (by weight) and the weight ratio of casein to whey proteins is between about 95:5 and about 50:50, preferably between 90:10 and 70:30, most preferably between 90:10 and 80:20. Such concentrates are known in the art. MPCs are frequently described with the % dry matter as milk protein being appended to “MPC”. For example MPC70 is an MPC with 70% of the dry matter as milk protein. Generally MPCs are prepared by processes invoking ultrafiltration either to prepare a stream enriched in casein or a stream enriched in whey protein. The streams may be blended to attain desired ratios of casein to whey protein. In another embodiment, the milk protein concentrate may be prepared by blending a stream of skim milk with a stream of whey protein concentrate prepared by ultrafiltration, treating either the skim milk stream or the combined stream by cation exchange and optionally concentrating or drying.

The mixing to form the stabilised food composition involves application of shear forces to reduce lipid droplet size preferably to an average of less than 100 microns, more preferably less than 50 microns, most preferably less than 20 microns. This may be achieved by homogenisation.

For some embodiments high shear stirring, for example, in a blade mixer (for example an Ultra Turrax or Waring blender) may be used.

A “stabilised food or drink” is a food or drink that either or both has more texture or is more stable to separation into different phases than the corresponding food or drink without the calcium-depleted MPC.

A “stabilised emulsion” is an emulsion that is more stable to separation than the corresponding emulsion or mixture without the calcium-depleted MPC.

The term “texture” refers broadly to a Rheological property of a food composition containing the ingredient of this invention. Rheological properties include gel and foam strengths, viscosity and stress-strain characteristics when subject to either static or dynamic deformation. The texture of foodstuffs is important in terms of ease of handling, stability during keeping and defining shelf-life and most importantly as a part of the product's sensory characteristics—namely the consumers' perceptions during mastication.

“Syneresis” refers to the propensity of a gel or foam to progressively weep or exude fluid over time. Generally, in cheese making, syneresis is a desired phenomenon resulting in the expulsion of the whey from the curd (the faster the better). Broadly, in this invention, syneresis is an undesired characteristic of the product where stability over time is preferred.

A protein dispersion is a food product where the protein is in a particulate or micellar form suspended or dispersed amongst a continuous phase.

Calcium-depleted MPCs for use in the invention may be prepared according to the methods of WO01/41578.

The calcium-depleted MPC may be prepared by a method comprising:
(a) providing an MPC having at least 40% dry matter as milk protein in aqueous solution/suspension (on a moisture-free and fat-free weight basis);
(b) removing of calcium ions therein by a method chosen from at least one of (1) cation exchange on an ion exchanger charged substantially with a single species of monovalent cation, (2) acidification to pH 4.6-7 with subsequent dialysis and/or ultrafiltration and/or diafiltration or (3) by addition of a chelating agent and/or binding a proportion of calcium ions with a chelating or sequestering agent.

The term, calcium ions, is used broadly and includes ionic calcium and colloidal calcium unless the context requires otherwise.

The term, magnesium ions, is used broadly and includes ionic magnesium and colloidal magnesium unless the context requires otherwise.

The term “charged substantially with a single species” indicates that a resin has at least 90% of the exchangeable ions as a single species, preferably at least 95%. In particular, the term indicates that resin is not prepared by mixing of resins bearing different species or that the resin has undergone a treatment calculated to provide charging with more than one type of ion. In this aspect of the invention it is contemplated, for example, that a small proportion of the cations bound to a cation exchange resin may be resistant to exchange with the desired cation.

In another method the calcium-depleted MPC is prepared comprising:
(a) providing a low fat milk solution, for example skim milk, in liquid form;
(b) removing of calcium ions therein by a method chosen from at least of (1) cation exchange on an ion exchange in a form bearing a monovalent cation species, or (2) acidification to pH 4.6-7 optionally with subsequent dialysis; and
(c) concentrating the solution obtained by ultrafiltration, optionally with diafiltration, to form an MPC or MPI having at least 40% dry weight of protein.

Calcium depleted MPCs are MPCs in which the calcium content is lower than the corresponding non-depleted MPC. These products generally also have a lower content of divalent cations, for example, magnesium, than corresponding non-depleted products.

The calcium-depleted MPC is preferably dried and then redissolved in the composition to be emulsified or in an aqueous component of it. Preferably, the MPC has at least 55% (on a moisture and fat-free basis), more preferably to least 70% protein and most preferably to least 80% protein. The MPC preferably has at least 30% of the calcium replaced by monovalent cations, more preferably at least 55% calcium replaced with monovalent cations, more preferably at least 70%. A preferred monovalent cation is the sodium ion. Other monovalent cations that are contemplated include potassium or ammonium.

Calcium depleted MPC may be heat treated. WO2004/057971 describes a heat treated and decalcified milk protein concentrate (HY-MPC) that is a calcium-depleted MPC having whey proteins denatured. The denaturation is carried out by heating at a temperature above 65° C. for sufficient time to allow denaturation of whey proteins. The heating is generally carried out at a pH of 6.0-7.0, preferably 6.5-7.0. Preferably, heating is for at least 4 minutes in this embodiment.

Preferably the calcium-depleted MPC is dried to a moisture content of less than 5%, or a water activity level than facilitates storage of the dry ingredient for several months without undue deterioration.

In another aspect, the ingredient of this invention may be blended with at least one other ingredient to produce a blend. Preferably the blend is a dry blend. Useful blends include blends of the calcium-depleted MPC with whey protein concentrates (WPCs).

Preferred MPCs for use in the invention have calcium removed by a cation exchange method. Preferably the cation exchange has been carried out on a resin bearing strongly acidic groups, preferably sulfonate groups.

A preferred strong acid cation exchange resin for use in this and other embodiments of the invention is IMAC HP 111 E, or equivalents such as SR1LNa, both manufactured by Rohm & Haas. This resin has a styrene divinylbenzene copolymer matrix. The functional groups are sulphonic acid groups that can be obtained in the Na⁺ form or alternatively converted to the K⁺ form. The use of the Na⁺ or K⁺ form is preferred.

The MPC applied to the cation exchanger preferably has the pH in the range of 5.6-7.0, more preferably 5.6-6.2. Once the MPC or MPI has passed through the column, its pH increases. If it increases above 7.0, it will generally be adjusted to about 6.5-7.0 to make it more palatable.

In those embodiments in which calcium removal is by acidification and subsequent dialysis and/or ultrafiltration and/or diafiltration, the pH is adjusted to be in the range 4.6-7, preferably 4.6-6.8, more preferably 4.6-6.7, most preferably 4.8-6.5. The membrane chosen generally has a nominal molecular weight cut off of 10,000 Daltons or less. A preferred ultrafiltration membrane is a Koch S4 HFK 131 type membrane with a nominal molecular weight cut off at 10,000 Daltons. The adjustment of the pH may be made with any acid suitable for adjusting the pH of a food or drink e.g., dilute HCl, dilute H₂SO₄, dilute acetic acid, dilute lactic acid, preferably dilute citric acid. For this method it is preferred to neutralise the solution to obtain a pH of 6.4-7.0 after calcium removal. This neutralisation is preferably carried out before any drying step.

When the calcium removal is by way of addition of a chelating agent, preferred chelating agents for use include citric acid, EDTA, food phosphates/polyphosphates, food acidulants, tartaric acid, citrates and tartrates. The preferred chelating agents are food acidulating agents. The chelating agents may be used before, during or following ultrafiltration or diafiltration stages or independently of an ultrafiltration or diafiltration.

The application of the ingredient of this invention is useful in facilitating fat emulsion stability in a wide variety of applications that involve fat droplet dispersions in an aqueous-based continuous phase. Non-limiting applications include, whole milk, buttermilk, filled and imitation milks, milk powders and filled milk powders, fat containing retentate powders, reconstituted milks, retentates and creams, coffee creamer and coffee whitener, ice-cream, infant formula, yoghurt (including set, stirred and drinking), mousse, soups, sauces, liqueurs, meat products, pet foods, mayonnaise, snack products, chocolate, confectionary, fat containing gels and the like.

The invention is particularly advantageous for foods or drinks comprising at least 50% water. Such foods include gelled and textured foods.

As ingredients, the calcium depleted milk protein concentrates, used in the invention, have advantages over other potential ingredients. They have better solubility properties than the corresponding undepleted milk protein concentrates and better flavour than sodium caseinates. They are generally easier to disperse in aqueous solutions than either undepleted milk protein concentrates or caseinates. They also have advantages over skim milk products, for example, lower lactose content and more emulsifying activity for a given volume of powder. Lower lactose content is useful for consumers wishing to avoid lactose or carbohydrates. The greater emulsifying activity by volume is valuable for ease of transport and mixing into emulsions.

### BRIEF DESCRIPTION OF THE DRAWINGS

FIG. 1 is a graph showing the emulsifying properties (on a protein basis) for sodium caseinate (NaCas), NaMPC-1, Na MPC-2 and MPC85.

FIG. 2 is a graph showing the effect of the calcium content of a range of MPCs on their emulsifying properties.

### EXAMPLES

The following examples further illustrate practice of the invention.

### Materials

Materials used in the following experiments are coded according to the details below.
(1) SMP (Low heat skim milk powder, Fonterra Co-operative Group Limited, Auckland)
(2) MPC85 (ALAPRO 4850, Fonterra Co-operative Group Limited, Auckland)
(3) NaMPC-1 (ALAPRO 4861, Fonterra Co-operative Group Limited, Auckland)
(4) NaMPC-2 (ALAPRO 4862, Fonterra Co-operative Group Limited, Auckland)
(5) WPC-1 (Whey Protein Concentrate 131, Fonterra Co-operative Group Limited, Auckland, cheese whey derived protein concentrate)
(6) WPC-2 (Whey Protein Concentrate 132, Fonterra Co-operative Group Limited, Auckland, acid whey derived protein concentrate)
(7) Blend of NaMPC-2/WPC80-2 comprising 61.6% w/w NaMPC-2+38.4% w/w WPC80-2

(8) A corresponding control blend was prepared on the above basis using MPC85/WPC80-2.
(9) NaCaseinate (ALANATE180, sodium caseinate, Fonterra Co-operative Group Limited, Auckland),
(10) NaMPC-3 (Pilot plant produced Ca depleted MPC85—see Appendix following Example 9 for details).

Compositions for the above ingredients are summarised in Table 1.

TABLE 1
Summary of samples used in emulsifying properties trials

| | Protein | Calcium | Sodium |
|---|---|---|---|
| | (% as is | (% as is | (% as is |
| Sample | basis) | basis) | basis) |
| SMP | 33.4 | 1.24 | 0.39 |
| MPC85 | 83.1 | 2.2 | 0.08 |
| NaMPC-1 | 83 | 1.3 | 1.2 |
| NaMPC-2 | 83 | 0.44 | 2.3 |
| WPC-1 | 79.6 | 0.35 | 0.55 |
| WPC-2 | 79.3 | 0.19 | 1.51 |
| Blend NaMPC- | 81.6 | 0.34 | 2.00 |
| 2:WPC-2 | | | |
| Blend | 81.6 | 1.43 | 0.63 |
| MPC85:WPC-2 | | | |
| NaCaseinate | 92.7 | 0.03 | 1.12 |

### Example 1

### Emulsion Activity and Stability Test Method

### REFERENCES

James M J & Patel P D (1988) “Development of a Standard Oil-in-water Emulsification Test for Proteins”. Leatherhead Food Research Association Report No 631 Leatherhead, Surrey, England.
Pearce K N & Kinsella J E (1978). Emulsification properties of proteins: Evaluation of a turbidimetric technique. Journal of Agricultural & Food Chemistry, 26, 716-723.

### Test Principle

Emulsification requires particle size reduction of the dispersed phase and surface interaction to aid stability. This test prepares a 27% oil emulsion by mixing a 0.1% protein solution and oil in an Ultra-Turrax mixer at 15,000 rpm for 60 seconds. Interfacial protein-oil interactions result and an emulsion is formed. The degree of emulsification of the protein can be found by measuring the absorbance of the resulting emulsion (this relates to the total surface area of the emulsion i.e. mean particle size of the oil droplets). The stability of the emulsion is found by reading the absorbance of the emulsion again 30 minutes after the initial reading.

### Apparatus

Top-loading balance
500 mL stainless steel beakers
250 mL beakers
Mixing tubes
1 mL pipettes
Spectrophotometer LKB Biochrom Ultospec II, and 1 cm path square sample cells
10 mL syringes
250 mL conical flasks
pH meter
Vortex mixer

### Waterbath at 60° C.

Stirring equipment (including stirring blades)
Ultra-Turrax mixer—Model T18 or T24—with shaft S25N-18G.
Glass jars—60 mL, 42 mm internal diameter (BDH Laboratory Apparatus Cat No. 215/0345/DI)
Dimensions of the jar must be such that air is excluded during emulsification.
Jar lid attachment so that the jar can be screwed onto the shaft of the Ultra-Turrax at 5 mm from the base.

### Reagents

Dispersant test samples used:
NaCaseinate (control 1), (details as above);
MPC85 (control 2), (details as above);
NaMPC-1, (details as above);
NaMPC-2, (details as above).
   Distilled or reverse osmosis (RO) water
   Vegetable (soybean) oil

### Sample Preparation

### Preparation of Dispersing Agent in Water (Sample Solution)

1. Weigh and record the weight of a stainless steel beaker and stirrer blade.
2. Weigh in 196 (+0.5) g of RO water.
3. Weigh 4 g of ingredient sample into another beaker.
4. Stir the water to a deep vortex and slowly add the ingredient sample.
5. Stir at high speed for 2-4 min to fully disperse.
6. Slow the speed down and stir for a further 56-58 min (60 min total).
7. Stop stirring and reweigh beaker, stirrer and contents.
8. Add sufficient RO water to make the solution up to 200 g.
9. Tare a flask and prepare a 0.1% solution by diluting 10 g of sample solution to 200 g with RO water.

### Preparation of Emulsion

1. Weigh 38 (+0.05) g of sample solution into a glass jar.
2. Add 14 (±0.05) g of oil.
3. Measure 200 mL of RO water into 250 mL beakers (two for each sample).
4. Emulsify the sample/oil solution in the glass jar at 15,000 rpm for 60 sec.
5. Immediately draw up 10 mL of the emulsion into a syringe and leave to stand upright for 30 min.
6. Pipette 1 mL of the emulsion and add to the 200 mL RO water in a beaker.
7. Stir to mix.
8. Read the initial absorbance of the dilute emulsion at 500 nm (A₅₀₀1).
9. After 30 min, push out the bottom 5 mL of emulsion from the syringe into a mixing tube.
10. Mix on a vortex mixer.
11. Pipette 1 mL of this emulsion into the other 200 mL RO water in a beaker and mix.
12. Read the final absorbance at 500 nm (A₅₀₀2).

### Calculations

Emulsification Activity=(A₅₀₀1)

Emulsion Stability (%)=A₅₀₀2÷A₅₀₀1×100

### Results

Table 2 summarises the composition and emulsion stabilising properties of the samples evaluated.

TABLE 2
Composition of MPCs, absorption results
and emulsion stability results

| | MPC85 | | | NaCaseinate |
|---|---|---|---|---|
| | (Control 1) | NaMPC-1 | Na MPC-2 | (Control 2) |
| Protein (%) | 82 | 82 | 82 | 92 |
| Casein (%) | 65.6 | 65.6 | 65.6 | 89.2 |
| Whey (%) | 16.4 | 16.4 | 16.4 | 2.8 |
| Calcium (%) | 2.2 | 1.3 | 0.3 | 0.01 |
| Emulsion activity | 0.215 | 0.225 | 0.506 | 0.505 |
| (A₅₀₀) - | | | | |
| initial | | | | |
| Emulsion activity | 0.065 | 0.12 | 0.376 | 0.413 |
| (A₅₀₀) - | | | | |
| after 30 min | | | | |
| Emulsion stability | 30.2 | 53.3 | 74.3 | 81.8 |
| (%) | | | | |

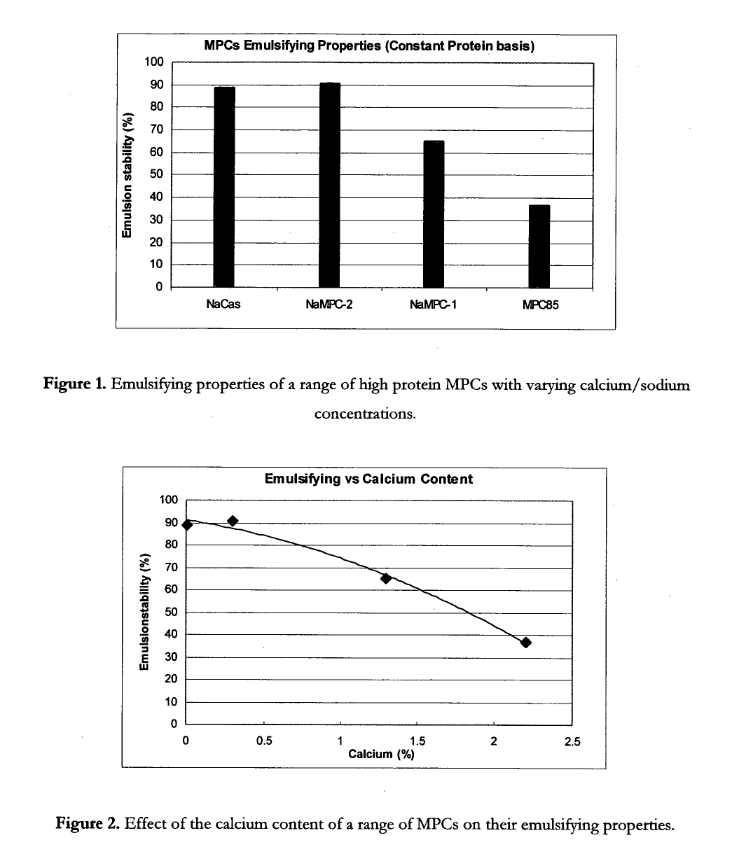

FIG. 1 shows that the ingredient of this invention had a surprisingly good emulsion stabilising effect—equivalent to or better than the sodium caseinate control. Other samples with a similar protein content but higher calcium concentrations and lower levels of sodium were less effective or ineffective at emulsion stabilisation. The trend in emulsion stability with varying calcium levels is shown in FIG. 2, with data from Table 1.

Repeat experiments using elevated whey protein:casein ratio (50:50)

Solutions were prepared on a 2% w/w protein basis

| | |
|---|---|
| MPC85 | 2.41 g made up to 100 g solution |
| NaMPC-2 | 2.44 g made up to 100 g solution |
| NaMPC-2/WPC-2 blend | 2.48 g made up to 100 g solution. |
| MPC85/WPC-2 blend | 2.48 g made up to 100 g solution. |

These solutions were diluted 10 g to 200 g with RO water to make the 0.1% protein solutions used in the emulsification test. The test method is as disclosed above.

Results of latest emulsion tests on NaMPC-2 and blend with WPC are summarised in Table 3 and illustrated in FIG. 3.

TABLE 3
Summary of results of second emulsifying properties
incorporating whey protein

| | | | Solutions made on | | |
|---|---|---|---|---|---|
| | | | a protein basis | | |
| | | | Emulsion | | |
| | | Protein | activity | | Emulsion |
| | Casein:whey | content | Abs | After 30 min | Stability |
| Product | protein ratio | % | 500 nm | Abs 500 nm | % |
| MPC85 | 80:20 | 83 | 0.181 | 0.029 | 16.02 |
| NaMPC-2 | 80:20 | 82 | 0.487 | 0.381 | 78.23 |
| NaMPC- | 50:50 | 80.8 | 0.454 | 0.363 | 79.96 |
| 2/WPC-2 | | | | | |
| blend | | | | | |
| MPC85/ | 50:50 | 81.5 | 0.265 | 0.043 | 16.23 |
| WPC- | | | | | |
| 2 blend | | | | | |

### Example 2A

### Application of NaMPC as Yoghurt Texture Improver

This trial was carried out in order to investigate a range of potential yoghurt texture improver solutions based on MPC and WPC's. Three MPC's, one standard, and two calcium depleted samples (commercial and pilot plant manufacture), were mixed with one of two WPCs, derived from either acid or cheese whey, at a ratio of 60:40 casein to whey protein. Samples were compared to samples standardised to the same protein levels using SMP, and were also compared to the use of sodium caseinate mixed with the whey proteins. Sodium caseinate was tested with the whey proteins as a control.

### Objectives

The potential of a range of dairy proteins to act as yoghurt texture improvers based on combinations of MPC and WPC was investigated.
The effect of replacing caseinate with NaMPC in typical yoghurt texture improver systems was observed.

### Materials and Methods

### Casein Source

NaCaseinate (details as above)
MPC85 (details as above)
NaMPC-2 (details as above)
NaMPC-3 (details as above)

### Whey Protein Source

WPC-1 (details as above)
WPC-2 (details as above)

### Experimental

The yoghurt texture improvers were prepared by blending a casein source with either WPC-1 or WPC-2 to give a 60:40 casein to whey ratio.

The model system used was a skim milk yoghurt with a total protein of 4.5%, the yoghurt texture improvers were added a level of 0.6% protein, with the rest of the protein coming from skim milk powder. Total solids in the yoghurt system were equalised by balancing with the addition of an equivalent quantity of lactose.

### Yoghurt Manufacture

The yoghurt was prepared according to the following method:
1. Weigh and pre-mix dry ingredients.
2. Recombine powders in hot water at 50-55° C., stirring for 10-15 mins to hydrate powders (4 L batch size).
3. Homogenise 150/50 bar (Rannie, Copenhagen) at 55° C.
4. Heat to 85° C. in the steam bath and hold for 15 mins.
5. Cool quickly in ice to 10° C. and then refrigerate till ready to add culture.
6. Warm the milks to about 40° C. and inoculate the milks with lactic starter culture YC-380 (Chr Hansen, Denmark) at 0.0255 g/L, and incubate at 42° C. to pH 4.5 (around 5-6 h).
7. Cool to 25° C.-20° C. in ice. (For stirred yoghurts, gently break up coagulum as it cools).
8. For stirred yoghurts, homogenise (Rannie, Copenhagen) with no pressure to smooth yoghurt, and pour into plastic bottles.
9. Pack and refrigerate.

### Yoghurt Model:

### Composition:

4.5% protein
about 0.2% fat
Total solids 12.79%

### Stirred Yoghurt Apparent Viscosity

The viscosity of stirred yoghurt was measured using a Haake VT500 Viscometer (Haake Mess-Technik, GmbH, Karlsruhe) fitted with the MV1 cup and cylinder. The viscosity measurements were performed at 10° C. (yoghurt sample straight from the fridge). The shear rate was increased from 0 to 120 s⁻¹ over a period of 3 min, then reduced to 0 s⁻¹ over 30 s. The apparent viscosity value as mPa×s (1 mPa×s=1 cP) at 50 s⁻¹ was recorded from the increasing shear rate sweep. Tests were performed in duplicate from different bottles.

### Set Yoghurt Texture Profile

The texture profile of set yoghurt was measured using a Universal TA-XT2 Texture Analyser with a real time graphics and data acquisition software package (XTRA Dimension) from Stable Micro Systems, Godalming, United Kingdom.

A 13 mm (0.5 inch) diameter Ebonite probe was driven vertically into the yoghurt sample (at 5° C. ex fridge) at a constant rate (1 mm/s) for a set distance (20 mm), then withdrawn the probe at a faster rate of 5 mm/s. The response as force (g) vs. time was measured. The force generated by the first penetration of the yoghurt (the first peak—fracture force) and the positive area under the force/time curve (Immersive effort) were recorded. The test was performed in triplicate from different bottles. The results are summarised in Table 4.

### TA-XT2 Settings

Force in Compression and Return to Start

| | |
|---|---|
| Parameters: | Pre test speed = 2.0 mm/s. |
| | Test speed = 1.0 mm/s. |
| | Post test speed = 5.0 mm/s. |
| | Rupture test distance = 1.0 mm. |
| | Distance = 20 mm. |
| | Force = 0.34N or 35 g |
| | Time = 25 sec. |
| | Count = 5 |
| Trigger: | Type = Auto |
| | Trigger Force = 5 g |
| | Stop Plot At = Trigger return |
| Break: | Detect = Off |
| | Force readout (units): g |

TABLE 4
Summary of yoghurt textures

| | | | | |
|---|---|---|---|---|
| | | | | Immersive |
| | | | | effort |
| | Vis- | | | Area |
| | cosity | Viscosity | Deformation | [arbitrary |
| Addition | (Pa × s) | (Pa × s) | force (gm) | units] |
| level (%) | Day 3 | Day 15 | Peak (Day 3) | (Day 3) |

Control 1

| | | | | | |
|---|---|---|---|---|---|
| NaCaseinate: | 0.6 | 0.54 | 0.51 | 47 | 751 |
| WPC-2 | | | | | |
| NaCaseinate: | 0.6 | 0.43 | 0.46 | 37 | 638 |
| WPC-1 | | | | | |
| replicate | 0.6 | 0.55 | 0.57 | 45 | 572 |

Using ingredient sample of the invention

| | | | | | |
|---|---|---|---|---|---|
| NaMPC-3: | 0.6 | 0.56 | 0.50 | 42 | 700 |
| WPC-2 | | | | | |
| NaMPC-2: | 0.6 | 0.49 | 0.53 | 39 | 756 |
| WPC-2 | | | | | |
| NaMPC-3: | 0.6 | 0.51 | 0.48 | 46 | 729 |
| WPC-1 | | | | | |
| NaMPC-2: | 0.6 | 0.54 | 0.54 | 41 | 744 |
| WPC-1 | | | | | |

Control 2

| | | | | | |
|---|---|---|---|---|---|
| MPC85: | 0.6 | 0.46 | 0.47 | 43 | 579 |
| WPC-2 | | | | | |
| replicate | 0.6 | 0.41 | 0.42 | 43 | 603 |
| MPC85: | 0.6 | 0.48 | 0.49 | 39 | 641 |
| WPC-1 | | | | | |
| replicate | 0.6 | 0.47 | 0.51 | 44 | 772 |

The ingredient blends of this invention performed comparably with blends of caseinate and whey protein.

### Example 2B

### Application and Comparison of Cation Modified Proteinate Blends in Yoghurt Texture Stabilisation

### Materials and Methods

### Casein Source

NaCaseinate (details as above)
NaMPC-2 (details as above)
Sodium caseinate [EM7] (DMV International, Veghel, The Netherlands)

### Whey Protein Source

WPC-2 (details as above)
WPC80-1 [Ultra Whey 80, 80% protein DB, whey protein concentrate] (Volactive Functional Food Products, Royston, United Kingdom)
WPC80-2 [Ultra Whey 80LF, 80% protein DB, whey protein concentrate] (Volactive Functional Food Products, Royston, United Kingdom)

### Experimental

Four samples were prepared, NaCaseinate+WPC-2 (Control 1) and sodium caseinate [EM7] with a WPC80-1 and WPC80-2 blend (Control 2) (See Table 5 for details) along with NaMPC-2 to give a 60:40 casein to whey ratio—Table 5.

The model system used was a skim milk yoghurt with a total protein of 4.5%, the yoghurt texture improvers were added at 1% protein, with the rest of the protein coming from skim milk. Total solids in the yoghurt systems were standardised by the use of lactose.

TABLE 5
Details of texture improver ingredient blending

| | | | |
|---|---|---|---|
| 1 | 2 | | |
| Control | Control | | |
| (1) | (2) | 3 | 4 |

| | |
|---|---|
| Sample | Blending % w/w |

| | | | | |
|---|---|---|---|---|
| NaMPC-2 | | | 74 | 74.3 |
| NaCaseinate | 56 | | | |
| EM7 | | 56.7 | | |
| WPC-2 | 44 | | 26 | |
| WPC80-2 | | 13 | | 7.7 |
| WPC80-1 | | 30.3 | | 18 |
| Sum | 100 | 100 | 100 | 100 |

The four blends from Table 5 were incorporated into the yoghurt formulations in Table 6.

TABLE 6
Details of formulations of yoghurt samples

| | | | | |
|---|---|---|---|---|
| | 1 | 2 | | |
| | (Control | (Control | | |
| Blend | 1) | 2) | 3 | 4 |

| | |
|---|---|
| ingredient sample | Formulation % w/w |

| | | | | |
|---|---|---|---|---|
| Dosage of blend above | 1.2 | 1.2 | 1.2 | 1.2 |
| into yoghurt | | | | |
| preparation | | | | |
| Water | 86.6 | 86.6 | 86.6 | 86.6 |
| SMP as skim milk | 10.5 | 10.5 | 10.5 | 10.5 |
| Lactose | 1.7 | 1.7 | 1.7 | 1.7 |
| Sum | 100.0 | 100.0 | 100.0 | 100.0 |

### Results

The viscosity results in Table 7 compared the texturising performance of the NaMPC-2-WPC blends with blends prepared from alternative commercial ingredients.

TABLE 7
Summary of viscosity of the yoghurt samples

| | | NaMPC-2 + | EM7 + | NaMPC-2 + |
|---|---|---|---|---|
| | NaCaseinate + | WPC-2 | WPC80 | WPC80 |
| | WPC-2 | (Sample | Blend | Blend |
| | (Control 1) | 3) | (Control 2) | (Sample 4) |
| Viscosity at | 404 | 400 | 433 | 448 |
| 50 s⁻¹ [cP] | | | | |

The NaMPC ingredient when blended with WPC gave as good texture as the sodium caseinate-WPC blends.

### Example 3

### Effect of Extent of Calcium Depletion on Yoghurt Texture

### Materials and Methods

SMP (details as above)
MPC85 (details as above)
NaMPC-1 (details as above)
NaMPC-2 (details as above)

### Experimental

Samples were prepared, using SMP, MPC85 and blends of NAMPC-1 and NaMPC-2 to give a range of calcium depletions, from 0% to >80% in the yoghurt texture improver ingredient.

Model systems were used with 3.5% protein and 4.5% protein, with 1% (in each case) coming from the yoghurt texture improver ingredient. In the model system the remaining protein was supplied by skim milk powder i.e. 2.5% and 3.5% respectively.

The compositions of the texture improver powders are shown in Table 8.

TABLE 8
Formulation and composition of texture improver powder samples

| Sample/blend | 1 | 2 | | | | |
|---|---|---|---|---|---|---|
| % w/w | (Control 1) | (Control 2) | 3 | 4 | 5 | 6 |
| SMP | 100 | | | | | |
| MPC85 | | 100 | | | | |
| NaMPC-1 | | | 100 | 60 | 25 | |
| NaMPC-2 | | | | 40 | 75 | 100 |
| Protein % | 33.4 | 83.1 | 83 | 83 | 83 | 83 |
| Calcium % | 1.24 | 2.2 | 1.3 | 0.96 | 0.66 | 0.44 |
| Calcium/protein | 0.037 | 0.0265 | 0.016 | 0.011 | 0.008 | 0.0053 |
| % Ca depletion | 0 | 29 | 58 | 69 | 79 | 86 |

### Results

The results of the yoghurt viscosity measured using the Haake viscometer at a shear rate of 50 s⁻¹ taken at 48 h and 168 h post culturing are shown in Table 9. Each point is an average of 2 viscosity determinations.

TABLE 9
Viscosity of yoghurt samples at 50 s⁻¹

| | Sample | | | | | |
|---|---|---|---|---|---|---|
| Viscosity | 1 | 2 | 3 | 4 | 5 | 6 |
| Pa × s (48 h, 3.5%) | 0.11 | 0.13 | 0.16 | 0.17 | 0.19 | 0.25 |
| Pa × s (168 h, 3.5%) | 0.10 | 0.14 | 0.13 | 0.20 | 0.19 | 0.28 |
| Pa × s (48 h, (4.5%) | 0.23 | 0.25 | 0.34 | 0.28 | 0.34 | 0.37 |
| Pa × s (168 h, 4.5%) | 0.22 | 0.28 | 0.38 | 0.30 | 0.36 | 0.38 |

The trends indicate that the removal of calcium from the yoghurt texture improver ingredient increased significantly the final viscosity of the yoghurt samples compared with the controls.

### Example 4

### Soup Using NaMPC-2 to Replace Sodium Caseinate

Objective: This Experiment Compared the Stabilisation Property of NaMPC-2 with NaCaseinate in a Model Soup System.

Background: Sodium caseinate is often used in soups for the purposes of whitening (by way of fat emulsion stabilisation) or for protein fortification. This soup recipe was selected with sufficient fat to compare the emulsification properties of the alternative proteins.

### Ingredients and Formulation:

Formulation to prepare soup samples is shown in Table 10.

TABLE 10
Summary of soup formulation

| | | By weight |
|---|---|---|
| Ingredients | % w/w | in grams |
| Unsalted Butter (Classic Farm - Universal Foods | 3.0 | 36 |
| Ltd, Palmerston North, New Zealand) | | |
| SMP | 6.25 | 75 |
| Milk Protein* | 0.7 | 8.4 |
| Native Tapioca Starch (Target Brand Tapioca | 1.30 | 15.6 |
| Starch, National Starch Food Innovation, | | |
| New Zealand) | | |
| Maltodextrin (Maltrin 180, Salkat NZ Ltd) | 3.0 | 36 |
| Sugar (Extra fine, Chelsea Sugar Refining Co. | 1.0 | 12 |
| Ltd., Auckland) | | |
| Onion powder (sieved from Maggi Onion Soup, | 0.25 | 3 |
| Nestle NZ Ltd) | | |
| Chicken seasoning (Firmenich New Zealand Ltd.) | 0.25 | 3 |
| Salt (common table salt) | 0.25 | 3 |
| Total Solids | 16.0 | 192 |
| Hot Water | 84.0 | 1008 |
| Total | 100.0 | 1200 |

*Formulated with NaCaseinate as the control. NaCaseinate was replaced by an equal weight of NaMPC-2.

### Method

1. Melt butter in beaker on stove top at low (heat 1) until just melted.
2. Stir in SMP and milk protein powder and mix well.
3. Dry blend all the other dry powders
4. Combine dry blend with fat/protein mixture in a food processor for 1 minute.
5. Add hot water (about 80° C.) and immediately disperse using Barmix blender on speed #1 for about 30 seconds.

### Evaluation

An informal sensory panel was used, on the same day immediately after step 5, to evaluate the formulations. The temperature of the soups when evaluated was around 40-50° C. Key points from the evaluation were;
1. There was no noticeable difference between the two formulations in terms of flavour, colour and texture.
2. Both soups were palatable with pleasant flavour and texture.
3. No visible oily layer was seen in either of the formulations.

The NaMPC-2 was capable as acting as an equivalent replacer for NaCaseinate in a soup system.

### Example 5

### Stabilisation Properties of NaMPC in a Whipped Topping Formulation

### Materials:

Confectionery fat, Confectionary Fat 92 (Goodman Fielder Food Service New Zealand Limited, Auckland)
   Corn syrup (Penford)
   Sucrose, Chelsea, granulated standard 1A (NZ Sugar Refining Co., Auckland)
   NaCaseinate (details as above)
   NaMPC-2 (details as above)
   MPC85 (details as above)
   Polyoxyethylene(20)sorbitan monostearate (Polysorbate 60—supplied by Bronson & Jacobs)
   Sorbitan monostearate (Liposorb S—supplied by Bronson & Jacobs)
   Xanthan gum, Grinsted, Xanthan 80 (Danisco)
   Guar gum, NP36 (Danisco)

### Formulations:

The formulations of the samples prepared using 1% protein are shown in Table 11.

TABLE 11
Summary whipping cream formulations

| | NaCaseinate | NaMPC-2 | NaMPC-2 | MPC85 |
|---|---|---|---|---|
| | (Control 1) | (1) | (2) | (Control 2) |
| Ingredient | g | g | g | g |
| Water | 1450.2 | 1447.9 | 1447.9 | 1447.9 |
| Fat | 600.0 | 600.0 | 600.0 | 600.0 |
| Corn syrup | 750.0 | 750.0 | 750.0 | 750.0 |
| Sucrose | 150.0 | 150.0 | 150.0 | 150.0 |
| NaCaseinate | 33.0 | | | |
| NaMPC-2 | | 35.3 | 35.3 | |
| MPC85 | | | | 35.3 |
| Polysorbate 60 | 8.4 | 8.4 | 8.4 | 8.4 |
| Sorbitan | 3.3 | 3.3 | 3.3 | 3.3 |
| monostearate | | | | |
| Xanthan gum | 3.6 | 3.6 | 3.6 | 3.6 |
| Guar gum | 1.5 | 2.5 | 1.5 | 1.5 |

### Preparation of Emulsion

The fat was melted in hot water. The dry ingredients were blended together, the Polysorbate 60 was melted before weighing out and added to the dry blend. The ingredients were all mixed together with a Heidolph RZR1 overhead stirrer (Heidolph, Kehleim, Germany). The mix was heated to 60° C. and a pre-emulsion was prepared by mixing with an Ultra turrax T50 mixer (IKA Works Inc., Wilmington, N.C. 28405, U.S.A.) on full speed for 1 min. The pre-emulsion was heated to 75° C. and homogenised at 52/3.5 MPa (520/35 bar) with an APV Rannie LAB type 12.5H homogeniser (APV Rannie, Albertslund, Denmark). The samples were cooled to 5° C. in an ice/water bath and placed in cool room at 4° C. to age.

### Evaluation of Samples

After aging for 45 min in the cool room, the emulsions were subjected to a whipping test. 250 g of emulsion were placed in the bowl of a Hobart N-50 mixer (Hobart, North York, Ontario, Canada). The emulsion was whipped on speed 3 until it was adjudged that an end point had been reached. This was when the whisk was making definite cuts in the foam. The time was recorded as the whip time. If the whipped emulsion did not become stiff even on prolonged whipping, it was deemed as unsuitable.

The whipped emulsion was placed in a piping bag. A 120 mL LK container was tared and filled with unwhipped emulsion. The whipped emulsion was piped into the same container and excess whip was taken off the top with a spatula. The container and contents were weighed. Overrun was then calculated as:

$$Overrun = \frac{( \begin{matrix}Weight of unwhipped emulsion - \\ weight of whipped emulsion\end{matrix} )}{Weight of whipped emulsion} \times 100 \%$$

The stiffness of the whip was assessed with a Brookfield DV-1 (Brookfield Engineering, Middleboro Mass. 02346 U.S.A.) viscometer using a Helipath stand and an F T-bar spindle rotating at 0.3 rpm.

Stability of the whip was assessed by making piped rosettes and keeping them for 24 hours in a cool room. The rosettes were inspected and a subjective judgement was made as to whether there had been any substantial collapse of the whips

### Results and Discussion

The summary of the evaluation of the whipped cream samples is shown in Table 12.

TABLE 12
Results of whipped cream evaluation

| | | NaMPC-2 | | |
|---|---|---|---|---|
| Measurement | NaCaseinate | (1) | NaMPC-2 (2) | MPC85 |
| Whip time (s) | 120 | 120 | 120 | 120 |
| Overrun (%) | 180 | 180 | 181 | 170 |
| Viscosity (Pas) | 20.5 | 28 | 23 | 107 |
| Stability | Stable | Stable | Stable | collapsed |

(MPC85 emulsion was whipped for shorter time (90 s) and for a prolonged time, but a stable whip did not result in either case.

The function of protein in a whipped topping system is as the primary emulsifier during the production process. The protein preferentially binds to the fat/aqueous interface to provide a stable emulsion. During the aging process emulsifiers displace the protein from the interface and this aids in the whipping process when instability in the emulsion is required to promote fat globule interaction and the formation of a stable whip structure. The protein of choice in this application is sodium caseinate and the usage level would normally be about 1% protein. These experiments indicated at the level of 1% protein, the NaMPC-2 milk protein concentrate performed as well as sodium caseinate. MPC85 was inferior and did not form a stable whipped structure.

### Example 6

### Evaluation of NaMPC in Coffee Whitening Application

### 1. Materials:

Confectionery fat CF 92 (Goodman Fielder Food Service New Zealand Limited, Auckland)
Glucose syrup (A1975)
NaCaseinate (details as above)
NaMPC-2 (details as above)
GMS [Glycerol monostearate] (Admul™ MG42-04K)
Tartaric esters of monoglycerides (Panodan 160, Danisco)
Carrageenan (Lactarin CM2220, FMC)
Di-potassium hydrogen phosphate (BDH Lab Supplies, Poole, Dorset, UK)
Nestle Alta Rica dark freeze dried instant coffee
Citric acid

### 2. Formulations:

TABLE 13

| | 1 (Control) | 2 | 3 (replicate) |
|---|---|---|---|
| Ingredient | g | g | g |
| Water | 2,067.5 | 2,066.5 | 2,066.5 |
| Fat | 600.0 | 600.0 | 600.0 |
| Glucose | 300.0 | 300.0 | 300.0 |
| syrup | | | |
| NaCaseinate | 13.0 | | |
| NaMPC-2 | | 14.0 | 14.0 |
| GMS | 6.0 | 6.0 | 6.0 |
| Panodan | 6.0 | 6.0 | 6.0 |
| Carrageenan | 1.5 | 1.5 | 1.5 |
| K₂HPO₄ | 6.0 | 6.0 | 6.0 |

### 3. Preparation of Whitener Emulsion

The dry in gradients were blended. The glucose syrup, hot water and fat were placed in a stainless steel beaker and the contents were heated in a hot water/steam bath to melt the fat. The dry ingredients were added whilst stirring the contents with a Heidoliph RZR1 stirrer (Heidolph, Kehlheim, Germany). The temperature of the mix was brought to 60° C. and a pre-emulsion was made by agitating with an Ultra-turrax T50 high shear mixer at approximately 8,000 r.p.m. for one minute. The temperature was raised to 75° C. in the hot water/steam bath and homogenised at 20/5 MPa (200/50 bar) with an APV Rannie LAB Type 12.5H homogeniser. The emulsions were cooled to approximately 8° C. and transferred to a coolroom at 4° C.

### 4. Evaluation of Whitener Emulsions

4.1 Whitening

Coffee (2.5 g) was weighed into a 250 g beaker and boiling water was added to the 200 mL graduation. Whitener emulsion (20 mL) was immediately added with a Finnpipette (Labsystems Ltd). The resultant whitened coffees were then subjected to colour analysis with a Hunterlab Miniscan XE Plus colorimeter (Hunter Associates Lab Inc, Reston, Va., USA).

4.2 Feathering

Coffee was made with 6.25 g of coffee made up to 500 mL with boiling water. The coffee was cooled to 25° C. The pH was measured as 5.23. Further quantities of coffee were similarly made and the pH was adjusted to 5.0, 4.9 and 4.8 respectively. One hundred grams of coffee were heated to 85° C. in a microwave oven and 10 mL of whitener emulsion was added. Observations were then made on whether there was any emulsion breakdown.

### 5. Results and Discussion

5.1 Whitening

The results of the colour analysis are given in Table 1.

TABLE 14
Colour parameters of whitened coffees

| | | | | Whiteness |
|---|---|---|---|---|
| Protein | L* | a* | b* | Index |
| NaCaseinate | 41.56 | 12.45 | 33.64 | 31.43 |
| NaMPC-2 (1) | 41.08 | 12.71 | 34.10 | 30.75 |
| NaMPC-2 (2) | 41.26 | 12.63 | 34.01 | 30.96 |

5.2 Feathering

It was noted that there were a few ‘flecks’ on the surface of the coffees whitened at the natural pH indicating that there could have been a small amount of emulsion breakdown. There was little difference between the whitener containing NaCaseinate and the whitener containing NaMPC-2. The whitener emulsions contained only 0.4% protein whereas commercial whiteners would normally contain at least 1% protein. By using a low protein content, it was intended to produce a more stressed system to allow more differentiation between protein types. At pH 5.0, slight separation of the emulsion was noted with the emulsion containing sodium caseinate, but the NaMPC-2 samples only had slight flecks as with the natural pH coffee. At pH 4.9, the result was more clear cut with complete breakdown of the sodium caseinate emulsion and just partial breakdown of the NaMPC-2 emulsion. At pH 4.8 all emulsions broke down in the hot coffee.

### 6. Conclusion

NaMPC-2 will successfully stabilise a coffee whitener emulsion. The whitening effect of the NaMPC-2 emulsion was comparable with the whitening effect of the sodium caseinate emulsion.

Resistance to feathering was slightly better with the NaMPC-2 emulsion than with the sodium caseinate emulsion.

### Example 7

### Stabilisation of Caramel Formulation

### Experimental:

A standard caramel (control), one containing 1% (w/w) added NaMPC-2 and one containing 2% (w/w) added NaMPC-2 were prepared according to the procedure described by Steiner et al., 2003. The formulations are shown in Table 15.

Add palm oil and lecithin to saucepan and melt at low heat on stove

Add sugar, corn syrup, sweetened condensed milk [SCSM] and water simultaneously (pre-blend NaMPC-2 with sugar at 50:50 ratio ie 6 g+6 g for 1% NaMPC-2)

Mix using beater-mixer (Black & Decker Pulsar hand-held electric beater, Model MP30) using speed #3 with single blade until mixture gets to 100° C.

Stir with a big spoon and cook caramel to 119° C.—measure approximate cooking time from 100° C.

Transfer into round metal tins: 18 cm in diameter, 3 cm deep and allowed to cool down by siting the tins in cold water and then covering with plastic to prevent any moisture uptake/loss. The caramels were left at ambient for three days and then evaluated.

TABLE 15
Formulation of caramels

| | Control | 1% NaMPC-2 | 2% NaMPC-2 |
|---|---|---|---|
| Ingredient | (g) | (g) | (g) |
| water | 88.8 | 88.8 | 88.8 |
| sugar, fine | 181.8 | 181.8 | 181.8 |
| HFCS | 148.2 | 148.2 | 148.2 |
| SCSM* | 120 | 120 | 120 |
| palm kernel oil (Ncote 347) | 60 | 60 | 60 |
| soy lecithin (Topcithin 200) | 1.2 | 1.2 | 1.2 |
| NaMPC-2 | | 6 | 12 |
| Total (g) | 600 | 606 | 612 |
| cooking time to 119° C. | 16 mins | 14 mins | 13 mins |

SCSM*—sweetened condensed skim milk (Highlander Lite, Nestle)
High fructose corn syrup [HFCS] (supplied by JC Sherratt)
Hydrogenated palm kernel oil (Ncote 347) (supplied by Kauri NZ)
Topcithin 200 (Cargill Texturizing Solutions US, LLC., Decatur, IL. 62526, USA)

### Evaluation of Caramels Containing NaMPC-2

### Free Fat/Stickiness:

A pre-weighed 15 cm diameter #2 Whatman filter paper was placed onto the surface of the caramel for 10 minutes. The filter paper was removed and re-weighed.

TABLE 16
Results of free fat/stickiness evaluation

| | Filter | |
|---|---|---|
| Caramel | paper pre-wt, g | Filter paper post-wt, g |
| Control | 1.71 | n.d. (unstable product) |
| 1% NaMPC-2 | 1.79 | 1.79* (Stable product) |
| 2% NaMPC-2 | 1.73 | 1.74* (Stable product) |

Note:
No surface free fat was visible to the eye for any of the 3 samples.
n.d. Filter paper stuck to surface, and on removal approx 50-80 g of caramel was also removed. Sampled deemed to have failed test.
*No greasy marks were evident on the filter paper. Paper pealed cleanly from the surface of the caramel. The 0.01 g increase in weight of the 2% added NaMPC-2 was likely due to caramel, not fat.

### Appearance:

There was not a great deal of difference in the appearance of the samples, general comments are summarised in Table 17.

TABLE 17
Summary of appearance

| Caramel | Surface | Interior |
|---|---|---|
| Control | Dark brown, | Brown, glossy |
| 1% NaMPC-2 | Dark brown | Brown, glossy |
| 2% NaMPC-2 | Lighter brown, entrapped | Brown, glossy |
| | air-bubbles on surface | |

### Informal Sensory:

Four panellists informally evaluated the flavour and textural properties of the caramels.

The flavour and texture evaluations are summarised in Table 18.

TABLE 18
Summary of sensory evaluation

| Caramel | Flavour | Texture |
|---|---|---|
| Control | Very sweet, syrupy | Sticky, tacky surface |
| | Not very caramel-like, | Slightly grainy in mouth |
| | Oily in mouth | Exhibited cold flow* |
| 1% NaMPC-2 | Very sweet | Non-sticky surface |
| | More caramel-like | Much firmer than control |
| | More dairy flavour | Not grainy |
| | | Toffee-like |
| | | Firmer texture, longer to |
| | | clear mouth |
| | | Less cold flow than |
| | | control* |
| 2% NaMPC-2 | Very sweet | Non-sticky surface |
| | More caramel-like | Much firmer than control |
| | More dairy flavour | Dissolves and clears |
| | | mouth quicker than 1% |
| | | Na-MPC |
| | | Less cold flow than |
| | | control* |

Note:
*Cold flow (slumping) can be defined as a measure of product deformability under its own weight over time (Foegeding & Steiner, 2002). In this case, cold flow refers to the flow of the caramel mass after cutting. For the control, any evidence of cutting was erased within 20 minutes, whereas for the NaMPC containing samples no slumping was evident for at least 2 hours.

### Discussion

The addition of NaMPC-2 to the caramel formulation conferred surprising benefits:
A reduction in cold flow which is important in applications such as when used as a layer in confectionery products or nutrition bars, and in sweets.
Reduction in surface stickiness. Important for wrapped sweets.
Increased caramel/dairy flavour.

### REFERENCES

Foegeding E A & Steiner A E (2002) Factors affecting caramel stickiness and texture. The Manufacturing Confectioner, 82, (5), 81-88.
Steiner A E, Foegeding, E A & Drake, M (2003) Descriptive analysis of caramel texture. Journal of Sensory Studies, 18, 277-289.

### Example 8

### Stabilisation in Meat System—Sausage Formulations

The major factors of interest in this project were the fat content, milk protein ingredient, and protein concentrations contained within the sausages.

In order to investigate the effect of these factors a factorial experiment was designed including:
Milk Protein Type: NaCaseinate (for details see above)
   MPC-85 (for details see above)
   NaMPC-2 (for details see above)
   NaMPC-1 (for details see above)
   Skim Milk Powder (for details see above)
   Control—No Protein
Protein Concentration:
   1%
   2%
Fat Content:
   150 g
   250 g

The sausage formulations were constructed by altering a standard sausage formulation as shown in Table 19A&B [samples 1-12]. A set of replicates was also prepared and is shown in Table 19A&B [samples 25-36].

The milk protein ingredients and compositional information were supplied by Fonterra Co-operative Group Limited of Palmerston North.

### 1. Sausage Production

Pork fat was sourced from the Goodman Fielder Meat Works, Longbum and gravy beef from Preston's Butchery, Palmerston North

### 1.2 Pre-Sausage Production

1. Sterilise all equipment (mincer, knives, bowels, chopping boards etc. . . . ) before use
2. Trim the gravy beef to better than 90% visual lean meat and remove any blood clots etc.
3. Cut the fat and beef into first sized chunks, which can be passed through the mincer
4. Mince the fat through an 5 mm plate, immediately followed by the beef through an 5 mm plate and collect in separate bowls.
5. Weigh out the minced fat and beef into polythene bags in the required quantities for each formulation and freeze at −24° C. until required.

### 1.3 Sausage Production

1. Remove the minced beef and fat from the freezer 12 hours before required and temper to 3-4° C. by placing in the chiller.
2. Add all the minced beef, salt, phosphates and spice to the bowl chopper.
3. Start the bowl chopper and slowly add one third of the ice water over the course of 30 seconds.
4. Add the milk powder protein and chop while slowly adding the remaining water over the course of 60 seconds.
5. Add the fat and chop for 30 seconds.
6. Add the flour if required and chop for a further 60 seconds.
7. Remove the batter and place into sausage filler, excluding as much air as possible.
8. Fill the batter into 30 mm sausage casings and tie.
9. Vacuum pack the sausages with a vacuum of 50 kPa.
10. Store at 3-4° C. overnight.
11. Freeze at −24° C. until required.

TABLE 19A
Meat formulations

| | Sample No. | | | | | |
|---|---|---|---|---|---|---|
| | Formulations | | | | | |
| | 1 | 2 | 3 | 4 | 5 | 6 |
| Ingredients | 25 | 26 | 27 | 28 | 29 | 30 |
| Fat Free Beef (g) | 600.0 | 500.0 | 600.0 | 500.0 | 600.0 | 500.0 |
| Pork Fat (g) | 150.0 | 250.0 | 150.0 | 250.0 | 150.0 | 250.0 |
| Ice/Water (g) | 166.5 | 166.5 | 166.5 | 166.5 | 166.5 | 166.5 |
| Flour (g) | 47.24 | 47.24 | 36.49 | 36.49 | 45.83 | 45.83 |
| Protein Type | NaCa | NaCa | NaCa | NaCa | MPC85 | MPC85 |
| Protein Amount (g) | 10.75 | 10.75 | 21.50 | 21.50 | 12.16 | 12.16 |
| Salt (g) | 17.0 | 17.0 | 17.0 | 17.0 | 17.0 | 17.0 |
| Spice Mix (g) | 5.0 | 5.0 | 5.0 | 5.0 | 5.0 | 5.0 |
| Sodium | 3.5 | 3.5 | 3.5 | 3.5 | 3.5 | 3.5 |
| Tripolyphosphate (g) | | | | | | |
| TOTAL (g) | 1000.0 | 1000.0 | 1000.0 | 1000.0 | 1000.0 | 1000.0 |

TABLE 19B
Meat formulations

| | Sample No. | | | | | |
|---|---|---|---|---|---|---|
| | Formulations continued | | | | | |
| | 7 | 8 | 9 | 10 | 11 | 12 |
| Ingredients | 31 | 32 | 33 | 34 | 35 | 36 |
| Fat Free Beef (g) | 600.0 | 500.0 | 600.0 | 500.0 | 600.0 | 500.0 |
| Pork Fat (g) | 150.0 | 250.0 | 150.0 | 250.0 | 150.0 | 250.0 |
| Ice/Water (g) | 166.5 | 166.5 | 166.5 | 166.5 | 166.5 | 166.5 |
| Flour (g) | 33.67 | 33.67 | 45.83 | 45.83 | 33.67 | 33.67 |
| Protein Type | MPC85 | MPC85 | NaMPC-2 | NaMPC-2 | NaMPC-2 | NaMPC-2 |
| Protein Amount (g) | 24.33 | 24.33 | 12.16 | 12.16 | 24.33 | 24.33 |
| Salt (g) | 17.0 | 17.0 | 17.0 | 17.0 | 17.0 | 17.0 |
| Spice Mix (g) | 5.0 | 5.0 | 5.0 | 5.0 | 5.0 | 5.0 |
| Sodium | 3.5 | 3.5 | 3.5 | 3.5 | 3.5 | 3.5 |
| Tripolyphosphate (g) | | | | | | |
| TOTAL (g) | 1000.0 | 1000.0 | 1000.0 | 1000.0 | 1000.0 | 1000.0 |

### 2.0 Testing

### 2.1 Propensity of Batter to Hold or Exude Water (Raw Sausage Meat)

1. Weigh approximately 0.3 g sample of sausage batter on a piece of Whatman #1 filter paper and record weight.
2. Place between two sheets of glass
3. Compress for 20 minutes with a 1 kilogram weight
4. Measure the area of the inner circle of batter film and the outer circle of moisture with a planimeter
5. Determine the relative water exuding propensity (WEP) by:

$$W E P = \frac{Moisture Area - Batter area}{Batter area}$$

Note that for this invention, lower WEP values are preferred over higher values i.e. more water is being retained in the batter.
6. Conduct three triplicate readings
Table 20 summarises the WEP values from the twelve formulations examined (with each formulation replicated).

TABLE 20
Summary of water exuding results

| | | WEP | | WEP |
|---|---|---|---|---|
| | | (ave. of 3 | | Average of 8 |
| | Fat | readings) | WEP (ave. of | values |
| Protein used | content | Samples | 3 readings) | (Smaller |
| [level %] | % | 1-12 | Samples 25-36 | values better) |
| NaCaseinate [1] | 15 | 0.295 | 0.361 | 0.294 |
| NaCaseinate [1] | 25 | 0.161 | 0.314 | |
| NaCaseinate [2] | 15 | 0.371 | 0.392 | |
| NaCaseinate [2] | 25 | 0.233 | 0.223 | |
| NaMPC-2 [1] | 15 | 0.353 | 0.384 | 0.255 |
| NaMPC-2 [1] | 25 | 0.197 | 0.260 | |
| NaMPC-2 [2] | 15 | 0.208 | 0.291 | |
| NaMPC-2 [2] | 25 | 0.180 | 0.164 | |
| MPC85 [1] | 15 | 0.353 | 0.342 | 0.288 |
| MPC85 [1] | 25 | 0.201 | 0.312 | |
| MPC85 [2] | 15 | 0.310 | 0.370 | |
| MPC85 [2] | 25 | 0.227 | 0.193 | |

The results in Table 20 showed that the sodium modified MPC ingredient gave improved water retention in a raw comminuated meat system than the controls.

### Example 9

1000 L of UF permeate is prepared by reconstituting in water 100 kg of dried permeate powder (prepared as a by-product of the manufacture of MPC85). Sufficient calcium depleted MPC ingredient (85% protein on a dry basis and approximately 0.3% calcium) is added to the solution to attain a protein concentration of 3%. After mixing, the solution is warmed to about 50° C. and pumped to a homogeniser. In the line feeding the homogeniser, soybean oil is dosed in continuously to yield a lipid fraction of about 4% in the flow-stream. The homogeniser is a 2-stage device operating at 200 Bar (first stage), 50 Bar (second stage). The homogenised stream is concentrated to approximately 50% solids in a multistage falling film evaporator and spray dried. A sample of the dried powder is added to water to give a 10% w/w solution and mixed to yield a stable solution.

### APPENDIX

### Manufacture of Calcium Depleted MPC85 (NaMPC-3)

About 900 L of MPI retentate was sourced from Fonterra Hautapu factory. This stream had about 16% total solids and a protein content of 90%. To this 100 L of skim milk was added to make a 1000 L of MPC₈₋₅ stream that had about 15.3% total solids and protein content of 86.0%. This MPC85 stream was diluted with 400 L of deminerlised water to make 1400 L of diluted MPC85 with solids content of about 10%. The pH of the diluted MPC85 stream was adjusted from 6.9 to 5.9 using about 200 L of 3% lactic acid. The pH adjusted MPC85 stream is passed through a previously prepared 125 L of strong cation resin (ROHM & HAAS, AMBERLITE SR1LNa) column to produce a calcium depleted MPC85 stream. This stream was then dehydrated using evaporation and drying steps to produce calcium depleted MPC85 ingredient with the following composition:

| | | | | Ash (including | |
|---|---|---|---|---|---|
| Fat | Moisture | Protein | Lactose | Calcium) | Calcium |
| 1.8% | 4.0% | 82% | 5.0% | 7.2% | 0.3% |

### Comprising

The term comprising as used in this specification means ‘consisting at least in part of’, that is to say when interpreting statements in this specification and claims which include that term, the features, prefaced by that term in each statement, all need to be present but other features can also be present.”

### Examples are Illustrations

The above examples are illustrations of the practice of the invention. It will be appreciated by those skilled in the art that the invention can be carried out with numerous modifications and variations. For example, the calcium-depleted MPCs used can show variations in protein concentration and calcium content, the method calcium depletion can be varied, the percentage calcium depletion and drying procedures can also be varied. Likewise, proportions and nature of the lipid and aqueous components may be varied.

1. A method for stabilising a food or drink that is an oil-in-water emulsion selected from whole milk, buttermilk, filled and imitation milks, milk powders, filled milk powders, fat containing retentate powders, reconstituted milks, retentates and creams, coffee creamer, coffee whitener, infant formula, soups, sauces, liqueurs and mayonnaise, wherein the method comprises a step selected from at least one of:
(a) adding a calcium-depleted milk protein concentrate to the food or drink;
(b) including a calcium-depleted milk protein concentrate in a composition comprising an aqueous phase and a lipid phase and mixing the composition to form a stabilised emulsion;
(c) mixing a calcium-depleted milk protein concentrate with aqueous dispersion of fat or protein, and subsequently mixing the resulting dispersion with an aqueous milk product or another food or drink comprising water; and
(d) dissolving a calcium-depleted dried milk protein concentrate in an aqueous fluid, adding a lipid or protein composition and applying shear to form a dispersion or emulsion.

2. (canceled)

3. (canceled)

4. (canceled)

5. A method as claimed in claim 1 wherein the stabilised food or drink comprises from 0.01% to 10% w/w of the calcium-depleted MPC on a dry basis.

6. A method as claimed in claim 5 wherein the stabilised food or drink comprises 0.1% to 5% (w/w) of calcium-depleted MPC on a dry basis.

7. A method as claimed in claim 1 wherein the milk protein concentrate comprises greater than 50% solids-not-fat as milk protein.

8. A method as claimed in claim 1 wherein the milk protein concentrate comprises greater than 55% solids-not-fat as milk protein.

9. A method as claimed in claim 7 wherein the milk protein concentrate comprises greater than 70% solids-not-fat as milk protein.

10. A method as claimed in claim 1 wherein the milk protein concentrate has at least 30% of the calcium replaced by monovalent cations.

11. A method as claimed in claim 1 wherein calcium in the milk protein concentrate has been replaced by sodium or potassium.

12. (canceled)

13. A method as claimed in claim 1 wherein the calcium removal is by cation exchange on an ion exchange resin bearing monovalent cations.

14. A method as claimed in claim 11, wherein the monovalent cations are sodium ions.

15. A method as claimed in claim 1, wherein calcium removal is by cation exchange on a single ion exchange resin bearing sodium ions.

16. A method as claimed in claim 1, wherein the protein stabilised food or drink comprises at least 50% water.

17. A method as claimed in claim 1, wherein the food or drink is selected from the group consisting of coffee creamer, coffee whitener, soups, and sauces.

18. A method for stabilising a yoghurt, wherein the method comprises including in the ingredients, a calcium-depleted milk protein concentrate.

19. A method as claimed in claim 18 wherein the stabilised yoghurt comprises from 0.01% to 10% w/w of the calcium-depleted MPC on a dry basis.

20. A method as claimed in claim 19 wherein the stabilised yoghurt comprises 0.1% to 5% (w/w) of calcium-depleted MPC on a dry basis.

21. A method as claimed in claim 18 wherein the milk protein concentrate comprises greater than 50% solids-not-fat as milk protein.

22. A method as claimed in claim 18 wherein the milk protein concentrate comprises greater than 55% solids-not-fat as milk protein.

23. A method as claimed in claim 21 wherein the milk protein concentrate comprises greater than 70% solids-not-fat as milk protein.

24. A method as claimed in claim 18 wherein the milk protein concentrate has at least 30% of the calcium replaced by monovalent cations.

25. A method as claimed in claim 18 wherein calcium in the milk protein concentrate has been replaced by sodium or potassium.

26. (canceled)

27. A method as claimed in claim 18 wherein the calcium removal is by cation exchange on an ion exchange resin bearing monovalent cations.

28. A method as claimed in claim 25, wherein the monovalent cations are sodium ions.

29. A method as claimed in claim 18, wherein calcium removal is by cation exchange on a single ion exchange resin bearing sodium ions.

30. (canceled)
